(19) United States
(12) Patent Application Publication
(10) Pub. No.: US 2010/0332182 A1
(43) Pub. Date: Dec. 30, 2010

(54) OPERATION DETERMINING SYSTEM, OPERATION DETERMINING DEVICE AND COMPUTER READABLE MEDIUM

(75) Inventors: Kazutoshi YATSUDA, Ashigarakami-gun (JP); Hiroyuki Hotta, Ashigarakami-gun (JP); Yasuyuki Saguchi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX Co., Ltd., Tokyo (JP)

(21) Appl. No.: 12/631,581

(22) Filed: Dec. 4, 2009

(30) Foreign Application Priority Data
Jun. 24, 2009 (JP) 2009-150365

(51) Int. Cl. G06F 15/00

(52) U.S. Cl. 702/152

(57) ABSTRACT

An operation determining system includes: a position measuring unit that measures a position of a moving object with time; and an operation determining unit that determines that there is an operation of the object in a detection area when an intersecting angle between entering and exiting vectors of the object with respect to the detection area, the intersecting angle being calculated based on the position of the object measured by the position measuring unit, is equal to or higher than a certain value.

### CROSS-REFERENCE TO RELATED APPLICATIONS

This application is based on and claims priority under 35 USC 119 from Japanese Patent Application No. 2009-150365 filed Jun. 24, 2009.

### BACKGROUND

### Technical Field

The present invention relates to an operation determining system, an operation determining device and a computer readable medium that determine the presence or absence of the operation of an object within a detection area.

### SUMMARY

According to an aspect of the present invention, there is provided an operation determining system including: a detection area that is positionally predetermined; a position measuring unit that measures a position of a moving object with time; and an operation determining unit that determines that there is an operation of the object in the detection area when an intersecting angle between entering and exiting vectors of the object with respect to the detection area, which is calculated on the basis of the position of the object measured by the position measuring unit, is equal to or higher than a predetermined value and determines that there is no operation of the object in the detection area when the intersecting angle is lower than the predetermined value, or determines that there is an operation of the object in the detection area when the intersecting angle is higher than the predetermined value and determines that there is no operation of the object when the intersecting angle is equal to or lower than the predetermined value.

### BRIEF DESCRIPTION OF THE DRAWINGS

Exemplary embodiments of the present invention will be described in detail based on the following figures, wherein:

FIG. 1 is a diagram showing an operation determining system according to an exemplary embodiment of the present invention;

FIGS. 2A to 2C are diagrams showing an intersecting angle between entering and exiting vectors of an object with respect to a detection area, wherein FIG. 2A shows a case where the detection area is two-dimensional, FIG. 2B shows a case where the detection area is three-dimensional, and FIG. 2C shows a route of the operation of the object in the detection area;

FIG. 3 is a block diagram showing one example of the configuration of an operation determining unit;

FIG. 4 is a flowchart showing an example of the processing in the operation determining unit;

FIGS. 5A to 5C are diagrams showing the speed rate of a lower speed of the object to a higher speed of the object at two places within the detection area, wherein FIG. 5A shows a case where the detection area is two-dimensional, FIG. 5B shows a case where the detection area is three-dimensional, and FIG. 5C shows a route of the operation of the object in the detection area;

FIG. 6 is a block diagram showing another example of the configuration of the operation determining unit;

FIG. 7 is a flowchart showing another example of the processing in the operation determining unit;

FIG. 8 is a diagram showing an example of a method of measuring the position of the object;

FIG. 9 is a diagram showing a method of calculating the three-dimensional position of a marker set having three or more basic markers; and

FIG. 10 is a diagram showing another example of the method of measuring the position of the object.

### DETAILED DESCRIPTION

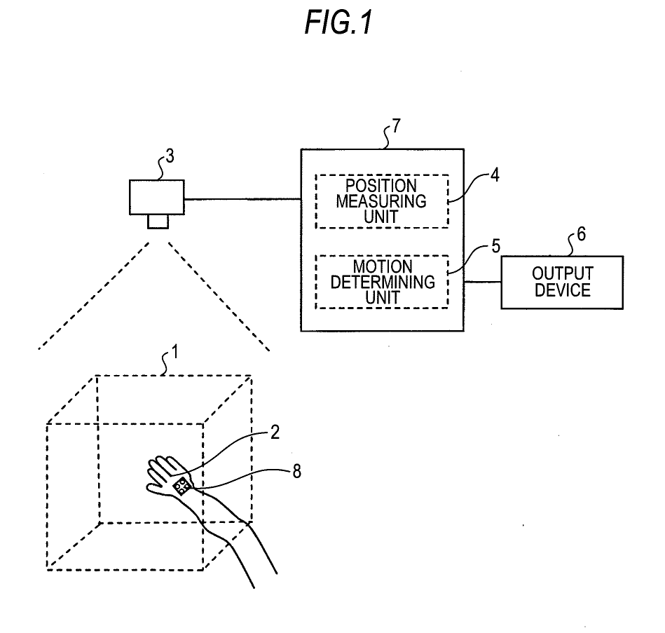

FIG. 1 is a diagram showing an operation determining system according to an exemplary embodiment of the present invention. This exemplary embodiment will be described by using a human hand as an example of an object which is targeted to determine the presence or absence of an operation (movement). However, the object of the present invention is not limited to the human hand, but it may be a human foot, the tip portion of a movable robot arm, the tip portion of a machine or tool, or the like. As shown in FIG. 1, this exemplary embodiment has a detection area 1 which has been positionally known, a position measuring unit 4 for measuring the position of a hand 2 as a moving object with time by using an image taking device 3, for example, and an operation determining unit 5 for determining that there is an operation of the hand 2 in the detection area 1 when an intersecting angle between entering and exiting vectors of the hand 2 with respect to the detection area 1, which is calculated on the basis of the position of the hand 2 measured with time, is equal to or higher than or higher than (exceeds) a predetermined (default) value and also determining that there is no operation of the hand 2 within the detection area 1 when the intersecting angle between the vectors is lower than or equal to, or lower than (falls below) the predetermined (default) value. Here, the operation (movement) is an operation based on the hand 2 such as insertion/pull-out of an article, assembly of the article, disassembly of the article, push, pull, rotation, touch or the like of the article within the detection area 1, however, the operation of this invention is not limited to these operations.

In this exemplary embodiment, as shown in FIG. 1, the position of the hand 2 is measured by measuring the position of a marker set 8 secured to the hand 2. An example of the configuration of the marker set 8 will be described later, however, three or more basic markers such as LEDs are fixed on a board such as a card to form the marker set 8, for example.

A position measuring method of the marker set 8 will be described later. The position measuring unit 4 and the operation determining unit 5 may be configured by using a personal computer (PC) 7 or the like, however, the present invention is not limited to this type. A determination result of the presence or absence of the operation of the hand (object) 2 may be output to an output device 6 such as a monitor. The configuration of each of the parts of this exemplary embodiment will be described in detail.

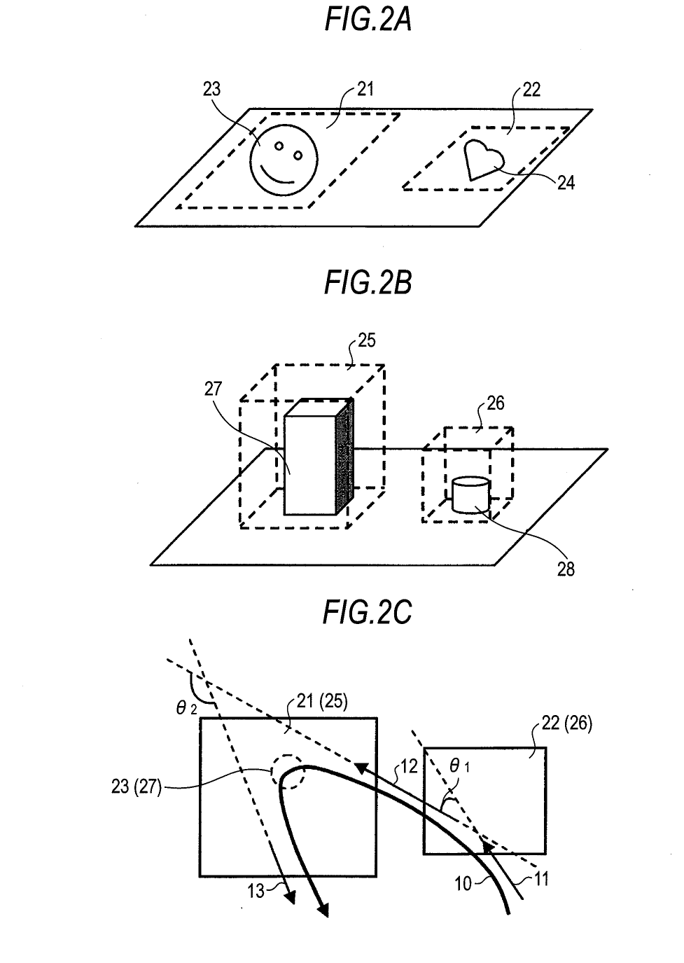

FIGS. 2A to 2C are diagrams showing the intersecting angle between the vectors of an object at the entrance/exit time of the object into/from the detection area. Specifically, FIG. 2A shows a case where the detection area is two-dimensional, FIG. 2B shows a case where the detection area is three-dimensional, and FIG. 2C shows a route of the motion of the object in the detection area. The detection area is set on the basis of position information obtained by a unit for measuring the position, for example, it is set two-dimensionally or three-dimensionally in the same display fashion as the x, Y, Z coordinates. One or plural detection areas may be arranged. Any shape may be adopted as the shape of the detection area insofar as it can be represented as an area (region). FIG. 2A shows a case where rectangular detection areas 21 and 22 are provided on the two-dimensional plane, and a face-like article 23 is placed in the detection area 21 while a heart-shaped article 24 is placed in the detection area 22. FIG. 2B shows a case where rectangular parallelepiped detection areas 25 and 26 are provided in the three-dimensional space. A rectangular parallelepiped article 27 is placed in the detection area 25 while a cylindrical article 28 is placed in the detection area 26. FIG. 2C shows the detection areas 21 and 22 on the two-dimensional plane for convenience of description, however, the same is applied to the case of the detection areas 25 and in the three-dimensional space. The two-dimensional detection areas 21 and 22 are used when the object is moved on the two-dimensional plane, however, the present invention is not limited to this type. For example, even when the object moves in the three-dimensional space, these detection areas 21 and 22 can be used by projecting the motion of the object onto the two-dimensional plane.

In FIG. 2C, in a case where the hand 2 moves along a route 10 shown in FIG. 2C to grasp the article 23 (27) in the detection area 21 (25), in the detection area 22 (26), an intersecting angle θ1 between an incident vector (a vector at the entrance time) 11 of the hand 2 into the detection area 22 (26) and an emitting vector (a vector at the exit time) 12 of the hand 2 from the detection area 22 (26) is smaller. On the other hand, in the detection area 21 (25), an intersecting angle θ2 between the incident vector (a vector at the entrance time) 12 of the hand 2 into the detection area 21 (25) and an emitting vector (a vector at the exit time) 13 of the hand 2 from the detection area 21 (25) is larger. Therefore, according to this exemplary embodiment, when the intersecting angle between both the vectors is equal to or higher than, or higher than (exceeds) a predetermined value, it is determined that there is an operation of the hand 2 in the detection area, and when the intersecting angle between both the vectors is lower than (falls below), or equal to or lower than the predetermined value, it is determined that there is no operation of the hand 2 in the detection area. It is based on a note that when the hand 2 has such an operation that the hand 2 grasps the article 23 (27) in the detection area, the intersecting angle θ between the vector at the entrance time into the detection area and the vector at the exit time from the detection area is increased unlike mere movement of the hand 2. This angle corresponds to an angle θ when the two vectors are represented by a and b and the inner (scalar) product a·b of both the vectors are represented by |a|·|b|cos θ. The predetermined value of the intersecting angle between both the vectors is preferably set to a value in a range from 30° to 180°. The foregoing point has been experimentally found out by the inventors of this application.

In this exemplary embodiment, the vectors 11, 12, 13 at the entrance/exit time of the object are determined based on the positions of the object at two places striding over the boundary of each detection area 21 (25), 22 (26). However, the present invention is not limited to this type, and the vectors may be determined according to the positions of the object at two places adjacent to the boundary of each detection area. In this case, the two adjacent places may be located out of the detection area or within the detection area. Here, when the two places are represented by coordinates, they correspond to a start point (x1, y1) and a terminal point (x2, y2) of the vector in the case of the two-dimensional plane, and a start point (x1, y1, z1) and a terminal point (x2, y2, z2) of the vector in the case of the three-dimensional space.

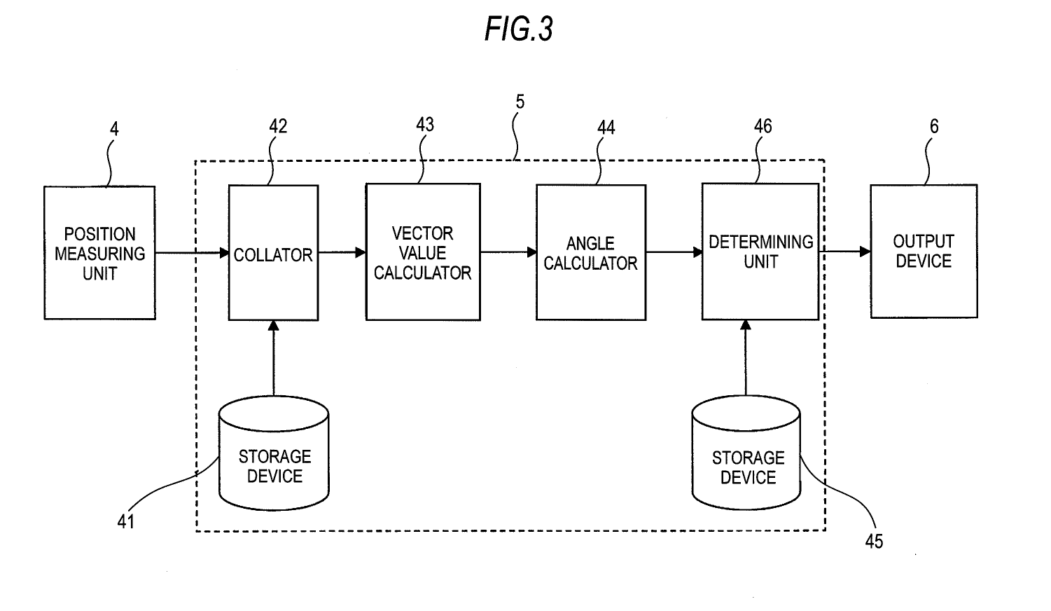

FIG. 3 is a block diagram showing an example of the configuration of the operation determining unit. The operation determining unit 5 is connected to the position measuring unit 4. The position measuring unit 4 measures the position of the moving object with time, and it is not limited to a specific one insofar as it can obtain two-dimensional or three-dimensional position information of the object. However, a so-called operation capture or a measuring method using basic markers are preferably used. These will be described later. As shown in FIG. 3, the operation determining unit 5 has a collator 42 for collating the position of the detection area obtained from a storage device 41 with the position of the object which is measured with time and obtained from the position measuring unit 4, a vector value calculator 43 for calculating the vector value at the entrance/exit of the object into/from the detection area by collating both the positions in the collating unit 42, an angle calculator 44 for calculating the intersecting angle between both the calculated entering and exiting vectors of the object, and a determining unit 46 for comparing the calculated intersecting angle between both the vectors with a predetermined value for determining the presence or absence of the operation obtained from the storage device 45, determining that there is an operation of the object in the detection area when the intersecting angle between both the vectors is equal to or higher than, or higher than the predetermined value, and determines that there is no operation of the hand 2 in the detection area when the intersecting angle between both the vectors is lower than, or equal or lower than the predetermined value. Here, one or both of the position measuring unit 4 and the operation determining unit 5 may be configured by using PC, for example. However, in this case, the storage devices 41 and 45 may be contained in PC or provided externally to PC. The determination result of the presence or absence of the operation of the object may be output to the output device 6 such as a monitor.

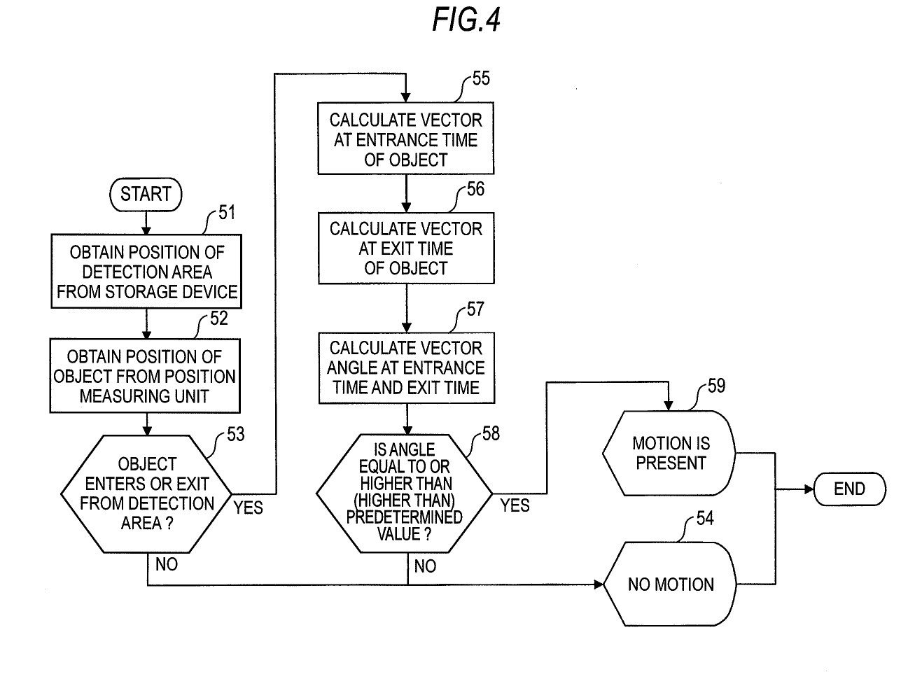

FIG. 4 is a flowchart showing an example of the processing in the operation determining unit. First, the position of the detection area is obtained from the storage device 41 in step 51. The position of the object which is measured with time is obtained from the position measuring unit 4 in step 52. In step 53, the position of the object obtained from the position measuring unit 4 is collated with the position of the detection area obtained from the storage device 41 to determine the presence or absence of entrance/exist of the object into/from the detection area. When the object neither enters nor exits, it is determined in step 54 that there is no operation of the object in the detection area. On the other hand, when there is either entrance or exist of the object, a vector at the entrance time of the object into the detection area is calculated in step 55. Subsequently, in step 56, a vector value at the exit time of the object from the detection area is calculated. In step 57, the intersecting angle between both the vectors is calculated from the calculated vector values at the entrance and exist times of the object. In step 58, the calculated intersecting angle between both the vectors is compared with a predetermined value for determining the presence or absence of the operation which is obtained from the storage device 45. As a comparison result, when the intersecting angle between both the vectors is equal to or higher than the predetermined value, or higher than the predetermined value, it is determined in step 59 that there is an operation of the object in the detection area. On the other hand, when the intersecting angle between both the vectors is lower than the predetermined value, or equal to or lower than the predetermined value, it is determined in step 54 that there is no operation of the object in the detection area.

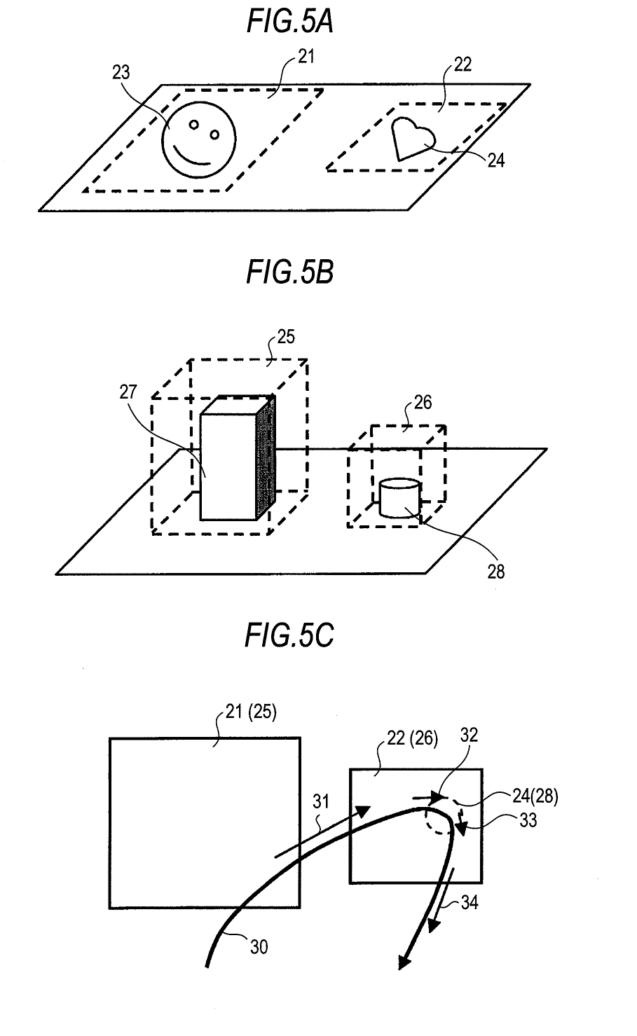

FIGS. 5A to 5C are diagrams showing the speed ratio of a lower speed of the object to a higher speed of the object at two places in the detection area, wherein FIG. 5A shows a case where the detection area is two-dimensional, FIG. 5B shows a case where the detection area is three-dimensional and FIG. 5C shows a route of the motion of the object in the detection area. The operation determining system according to another exemplary embodiment of the present invention will be described with reference to FIGS. 5A to 5C. This exemplary embodiment is different from the above exemplary embodiment in that the presence or absence of the operation of the object is determined on the basis of the speed ratio of a lower speed of the object to a higher speed of the object at two places within the detection area in place of the intersecting angle between the vectors at the entrance/exist time of the object into/from the detection area. That is, referring to FIG. 1, this exemplary embodiment includes a detection area 1 which has been positionally known, a position measuring unit 4 for measuring the position of a moving object such as a hand 2 with time by using an image taking device 3, and an operation determining unit 5 for determining that there is an operation of the hand 2 in the detection area when the speed ratio of a lower speed of the object to a higher speed of the object at two places within the detection area, which is calculated on the basis of the position of the hand 2 measured with time, is lower than a predetermined (default) value, or equal to or lower than the predetermined value, and also determining that there is no operation of the hand 2 in the detection area when the speed ratio concerned is equal to or higher than the predetermined value, or higher than the predetermined value.

In FIG. 5A, a rectangular detection areas 21 and 22 are provided on the two-dimensional plane, and a face-like article 23 is placed in the detection area 21 while a heart-shaped article 24 is placed in the detection area 22 as in the case of FIG. 2A. In FIG. 5B, rectangular parallelepiped detection areas 25 and 26 are provided in the three-dimensional space, and a rectangular parallelepiped article 27 is placed in the detection area 25 while a cylindrical article 28 is placed in the detection area 26 as in the case of FIG. 2B. In FIG. 5C, the detection areas 21 and 22 on the two-dimensional plane are illustrated for convenience of description, however, the same is applied to the case of the detection areas 25 and 26 in the three-dimensional space as in the case of FIG. 2C. The two-dimensional detection areas 21 and 22 are used when an object moves on the two-dimensional plane, however, the present invention is not limited to this type. Even when the object moves in the three-dimensional space, these detection areas may be used by projecting the motion of the object onto the two-dimensional plane.

In FIG. 5C, when the hand 2 moves along a route 30 shown in FIG. 5C so as to grasp the article 24 (28) in the detection area 22 (26), the speed of the hand 2 (arrow 31) in the detection area 21 (25) is high and does not decrease because there is no article to be grasped. Furthermore, when the hand 2 enters the detection area 22 (26), the speed of the hand 2 (arrow 31) is also high. However, the speed of the hand 2 (arrows 32, 33) decreases in the neighborhood of the article 24 (28) to be grasped. Thereafter, when the hand 2 exits from the detection area 22 (26), the speed of the hand 2 (arrow 34) increases. This exemplary embodiment is implemented by paying attention to this point. Accordingly, according to this exemplary embodiment, when the speed ratio of a lower speed of the hand 2 to a higher speed of the hand 2 at two places within the detection area is lower than a predetermined (default) value, or equal to or lower than the predetermined value, it is determined that there is an operation of the hand 2 within the detection area. On the other hand, when the speed ratio concerned is equal to or higher than the predetermined (default) value, or higher than the predetermined value, it is determined that there is no operation of the hand 2. The speed ratio may be set to the speed ratio of the minimum speed of the object in the detection area to the speed of the object when the object enters the detection area, for example. Alternatively, the speed ratio may be set to the ratio of the minimum speed to the maximum speed within the detection area. However, the present invention is not limited to this type. The predetermined (default) value of the speed ratio is preferably set to a value in the range from 10% to 80%. The foregoing points have been experimentally found by the inventors of this application. The speed of the object may be derived from the position of the object (position and time) measured with time which is obtained from the position measuring unit 4.

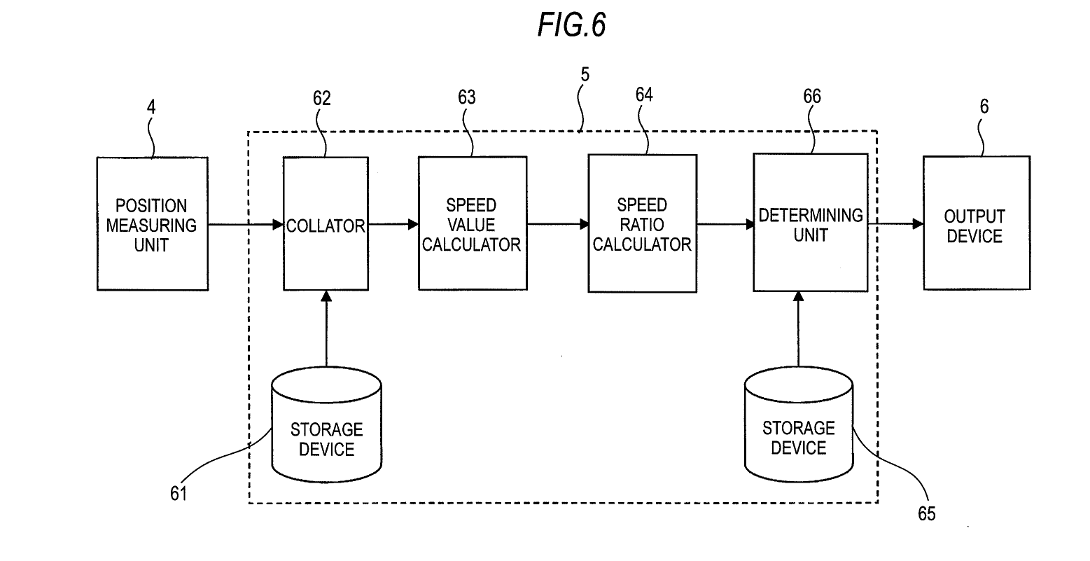

FIG. 6 is a block diagram showing another example of the configuration of the operation determining unit.

The operation determining unit 5 is connected to the position measuring unit 4. The position measuring unit 4 will be described later.

As shown in FIG. 6, the operation determining unit 5 includes a collator 62 for collating the position of a detection area obtained from a storage unit 61 with the position of an object which is measured with time and obtained from the position measuring unit 4, a speed value calculator 63 for calculating a speed value of the object at two places within the detection area by collating both the positions in the collator 62, a speed ratio calculator 64 for calculating the speed ratio of a calculated lower speed of the object to a calculated higher speed of the object at the two places, and a determining unit 66 for comparing the calculated speed ratio with a predetermined (default) value which is obtained from the storage device to determine the presence or absence of an operation of the object, determining that there is an operation of the object in the detection area when the calculated speed ratio is lower than the predetermined value, or equal to or lower than the predetermined value, and also determining that there is no operation of the object when the calculated speed ratio is equal to or higher than the predetermined (default) value, or higher than the predetermined value. Here, one or both of the position measuring unit 4 and the operation determining unit 5 may be configured by using PC, for example. In this case, the storage devices 61 and 65 may be contained in PC, or provided as an externally attachable device. The determination result of the presence or absence of the operation of the object may be output to an output device 6 such as a monitor.

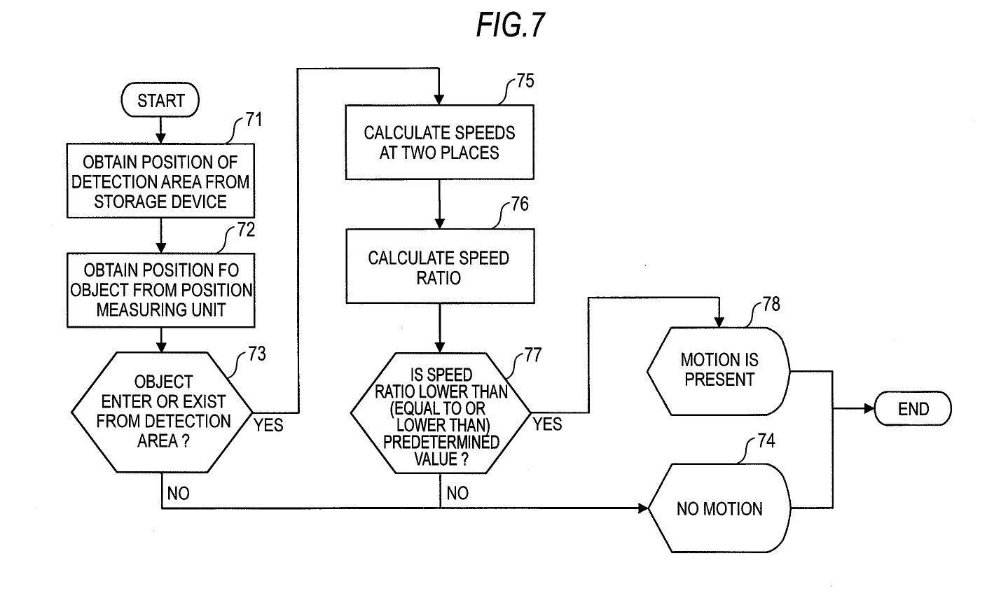

FIG. 7 is a flowchart showing another example of the processing in the operation determining unit.

First, in step 71, the position of the detection area is obtained from the storage device 61. In step 72, the position of the object which is measured with time is obtained from the position measuring unit 4. In step 73, the position of the object obtained from the position measuring unit 4 is collated with the position of the detection area obtained from the storage device 61 to determine the presence or absence of the entrance/exist of the object into/from the detection area. When the object neither enters the detection area nor exits from the detection area (i.e., the entrance/exit is absent), it is determined in step 74 that there is no operation of the object in the detection area. On the other hand, when the object either enters the detection area or exits from the detection area (i.e., the entrance/exist is present), it is determined in step 75 that the speed values of the object at the two places within the detection area are calculated. Subsequently, in step 76, the speed ratio of the calculated lower speed (smaller speed value) of the object to the calculated higher speed (larger speed value) of the object at the two places is calculated. In step 77, the calculated speed ratio is compared with a predetermined (default) value for determining the presence or absence of the operation of the object which is obtained from the storage device 65. As a comparison result, when the calculated speed ratio is lower than the predetermined value, or equal to or lower than the predetermined value, it is determined in step 78 that there is an operation of the object in the detection area. On the other hand, when the calculated speed ratio is equal to or higher than the predetermined value, or higher than the predetermined value, it is determined in step 74 that there is an operation of the object in the detection area.

The two exemplary embodiments described above may be combined with each other. This combined exemplary embodiment will be described with reference to FIG. 1. The combined exemplary embodiment has a detection area 1 which has been positionally known, a position measuring unit 4 for measuring the position of a moving object such as a hand 2 with time by using an image taking device 3, and an operation determining unit for determining that there is an operation of the hand 2 in the detection area when the intersecting angle between the vectors at the entrance/exist time of the hand into/from the detection area 1, which is calculated on the basis of the position of the hand 2 measured with time, is equal to or higher than a first predetermined value and also the speed ratio of a lower speed of the hand 2 to a higher speed of the hand 2 at two places in the detection area is equal to or lower than a second predetermined value, and determines that there is no operation of the hand 2 when the intersecting angle between the vectors is equal to or lower than the first predetermined value, or when the speed ratio is equal to or higher than the second predetermined value, or determines that there is an operation of the hand 2 in the detection area when the intersecting angle between the vectors is equal to or higher than the first predetermined value, or when the speed ratio is equal to or lower than the second predetermined value, and determines that there is no operation of the hand 2 when the intersecting angle between the vectors is equal to or lower than the first predetermined value and also the speed ratio is equal to or higher than the second predetermined value.

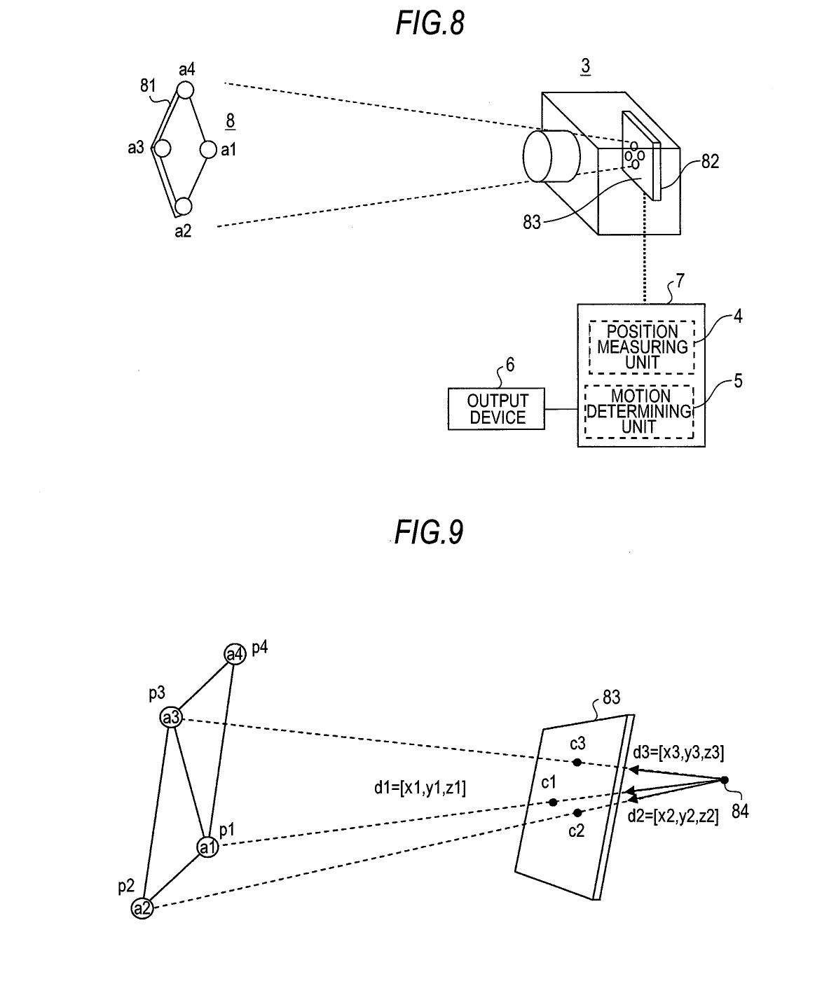

FIG. 8 is a diagram showing an example of the method of measuring the position of the object. In this exemplary embodiment, as shown in FIG. 1, a maker set 9 is secured to an object (hand 2), and the three-dimensional position of the marker set 8 is measured to measure the three-dimensional position of the object. As shown in FIG. 8, the marker set 8 has a board 81 such as a card, and four basic markers a1, a2, a3, a4 which are secured at four corners of the board 81 and whose positional relationship is known. A light source such as LED may be used as the basic marker, however, this invention is not limited to this type. For example, a retroreflective plate may be used in place of the light source, and an illumination device for illuminating the retroreflective plate may be provided. Furthermore, a pattern image having a peculiar shape may be used. The image taking device 3 has a two-dimensional image taking element 82 for taking an image of the marker set 8, and a general-purpose digital camera may be used. The position and angle of the marker set 8 are calculated on the basis of the image taken by the image taking device (camera) 3 by the position measuring unit 4. An example of the calculation of the position measuring unit 4 will be hereunder described.

FIG. 9 is a diagram showing an example of a method of calculating the three-dimensional position of the marker set having three or more basic markers.

The following description will be given on the assumption that a light source including an LED or the like is used as a basic marker. In this example, four light sources are arranged at the corners of a square, for example, and two combinations of three light sources out of the four light sources are considered. Two resolutions are derived from the following calculation by using the respective three points. One of the two resolutions corresponds to a case where all the light-source positions have the same values, and this resolution is set as a correct resolution, whereby the position and angle of the marker set can be determined.

First, in FIG. 9, the direction vectors di (i=1, 2, 3) of the light source positions in the camera coordinate system are calculated according to the relationship between imaging positions c1, c2, c3 on an imaging plane (the two-dimensional image taking element face of the camera) of light sources (basic markers) a1, a2, a3 and the optical center 84 of the camera. Here, di represents a normalized unit vector.

When the position vectors in the space of the light sources a1, a2, a3 are represented by p1, p2, p3, these position vectors are located on the extension lines of the di, and thus when the coefficients thereof are represented by t1, t2, t3, the following expression 1 is satisfied.

P1=t1·d1

P2=t2·d2

P3=t3·d3 (Ex. 1)

The shape of the triangle is known from the beginning, and when the lengths of the triangle are represented by the following expression 2,

p1p2=L1

p2p3=L2

p3p1=L3 (Ex. 2)

the following expression 3 is obtained. In the following expression 3, “̂” represents the power of a number. That is, “̂2” represents “2²”.

(t1x1−t2x2)̂2+(t1y1−t2y2)̂2+(t1z1−t2z2)̂2=L1̂2

(t2x2−t3x3)̂2+(t2y2−t3y3)̂2+(t2z2−t3z3)̂2=L2̂2

(t3x3−t1x1)̂2+(t3y3−t1y1)̂2+(t3z3−t1z1)̂2=L3̂2 (Ex. 3)

Ordering the above expression, the following expression 4 is obtained.

t1̂2−2t1t2(x1x2+y1y2+z1z2)+t2̂2−L1̂2=0

t2̂2−2t2t3(x2x3+y2y3+z2z3)+t3̂2−L2̂2=0

t3̂2−2t3t1(x3x1+y3y1+z3z1)+t1̂2−L3̂2=0 (Ex. 4)

Furthermore, the following expression 5 is obtained. In the following expression 5, “sqrt” represents square root.

t1=A1·t2±sqrt((A1̂2−1)·t2̂2+L1̂2)

t2=A2·t3±sqrt((A2̂2−1)·t3̂2+L2̂2)

t3=A3·t2±sqrt((A3̂2−1)·t1̂2+L3̂2) (Ex. 5)

where A1, A2, and A3 are represented by the following expression 6.

A1=x1x2+y1y2+z1z2

A2=x2x3+y2y3+z2z3

A3=x3x1+y3y1+z3z1 (Ex. 6)

The inside of the square root of the expression 5 is positive to have a real-number solution.

t1≦sqrt(L3̂2/(1−A3̂2))

t2≦sqrt(L1̂2/(1−A1̂2))

t3≦sqrt(L2̂2/(1−A2̂2)) (Ex. 7)

The real numbers t1, t2, t3 satisfying the above condition are successively substituted into the expression 5, and all of t1, t2, t3 which satisfy the expression 5 are calculated. Subsequently, p1, p2, p3, that is, the three-dimensional position of the light source (basic marker) is calculated on the basis of the above expression 1. When three light sources are provided, two solutions are obtained. In this case, four light sources are provided, and thus the same calculation is executed on the other three light sources (basic markers), for example, a1, a3, a4, and other two solutions are derived. One of the two solutions concerned corresponds to a case where all the light source positions have the same value, and thus this solution is set as a correct solution. The position of the marker set can be determined as described above. When three light sources are provided, the average value of the two solutions or one solution nearer to a given initial value is set as a value to be determined. The angle of the marker set can be determined as a direction in which the marker set faces from the determined three-dimensional position. This type of position detecting method has been known. The calculation method of the three-dimensional position of the basic marker (light source) is not limited to the above method, and another method may be used.

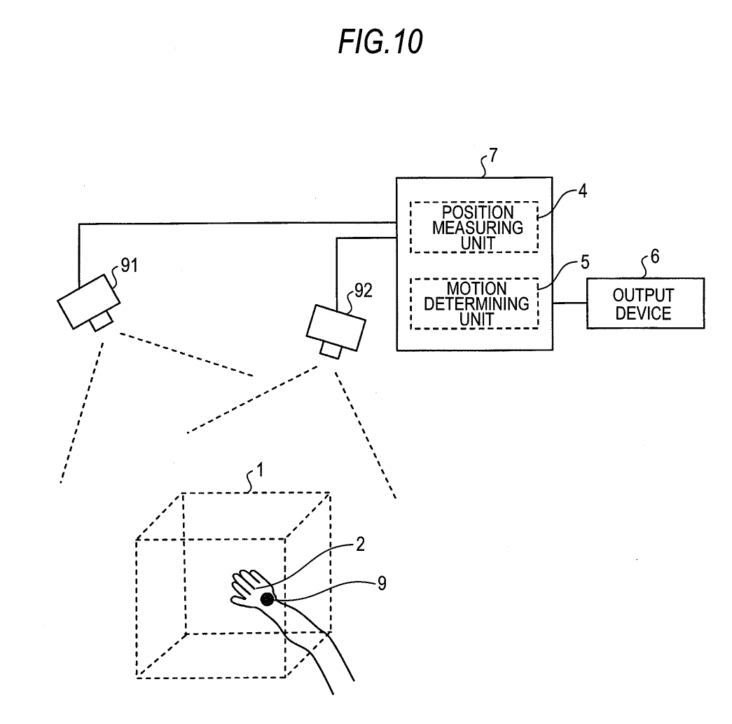

FIG. 10 is a diagram showing another example of the method of measuring the position of the object. This method uses an operation capture technique of taking an image of a marker 9 fitted to an object by using image taking devices 91 and 92 as shown in FIG. 10, and measuring the position (operation) of the object with time on the basis of the image taking information in the position measuring unit 4. A so-called retroreflective plate may be used as the marker 9, however, the present invention is not limited to this plate. This type of position detecting method has been known. In the example of FIG. 10, the position measuring unit 4 is the same as the above-described exemplary embodiment together with the determining method of the operation determining unit 5 except that the position measuring unit 4 measures the position of the hand 2 as an object with time by using the image taking devices 91 and 92 according to the operation capture technique.

The above procedure can be executed by making a computer execute the following program. That is, this program makes the computer execute: a step of determining whether the intersecting angle between entering and exiting vectors of a moving object with respect to a detection area which has been positionally known is equal to or higher than a predetermined (default) value, or higher than the predetermined value, the intersecting angle between the vectors at the entrance/exist time being calculated on the basis of the position of the object which is determined by measuring the position of the moving object with time; and a step of determining that there is an operation of the object in the detection area when the intersecting angle between the vectors is equal to or higher than the predetermined (default) value, or higher than the predetermined value, and also determining that there is no operation of the object in the detection area when the intersecting angle concerned is lower than the predetermined (default) value, or equal to or lower than the predetermined value.

Furthermore, this program makes the computer execute: a step of determining whether the speed ratio of a lower speed of a moving object to a higher speed of the object at two places in a detection area which has been positionally known is lower than a predetermined (default) value, or equal to or lower than the predetermined value, the speed ratio being calculated on the basis of the position of the object which is obtained by measuring the position of the moving object with time; and a step of determining that there is an operation of the object when the speed ratio is lower than the predetermined value, or equal to or lower than the predetermined value and also determining that there is no operation of the object when the speed ratio is equal to or higher than the predetermined value, or higher than the predetermined value.

Still furthermore, this program makes the computer execute: a step of determining whether the intersecting angle between entering and exiting vectors of a moving object with respect to a detection area which has been positionally known is equal to or higher than a first predetermined (default) value, or higher than the first predetermined value, the intersecting angle between the vectors at the entrance/exist time being calculated on the basis of the position of the object which is determined by measuring the position of the moving object with time; a step of determining whether the speed ratio of a lower speed of a moving object to a higher speed of the object at two places in a detection area which has been positionally known is lower than a second predetermined (default) value, or equal to or lower than the second predetermined value, the speed ratio being calculated on the basis of the position of the object which is obtained by measuring the position of the moving object with time; a step of determining that there is an operation of the object when the intersecting angle between the vectors is equal to or higher than the first predetermined value, or higher than the first predetermined value and also the speed ratio is lower than the second predetermined value, or equal to or lower than the second predetermined value, determining that there is no operation of the object when the intersecting angle between the vectors is lower than the first predetermined value, or equal to or lower than the first predetermined value, or the speed ratio is equal to or higher than the second predetermined value, or higher than the second predetermined value, determining that there is an operation of the object when the intersecting angle between the vectors is equal to or higher than the first predetermined value, or higher than the first predetermined area, or the speed ratio is lower than the second predetermined value, or equal to or lower than the second predetermined value, or determining that there is no operation of the object when the intersecting angle between the vectors is lower than the first predetermined value, or equal to or lower than the first predetermined value, and the speed ratio is equal to or higher than the second predetermined value, or higher than the second predetermined value. The program may be stored in a storage device contained in PC constituting the operation determining unit, for example, however, the present invention is not limited to this type. The program may be stored in a recoding medium such as CDROM, or supplied through a communication unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the skilled in the art to understand the invention for various embodiments and with the various modifications as are suited to the particular use contemplated. It is intended that the scope of the invention be defined by the following claims and their equivalents.

What is claimed is:

1. An operation determining system comprises:
a position measuring unit that measures a position of a moving object with time; and
an operation determining unit that determines that there is an operation of the object in a detection area when an intersecting angle between entering and exiting vectors of the object with respect to the detection area, the intersecting angle being calculated on the basis of the position of the object measured by the position measuring unit, is equal to or higher than a certain value.

2. An operation determining system comprises:
a position measuring unit that measures a position of a moving object with time; and
an operation determining unit that determines that there is an operation of the object in a detection area when a speed ratio of a lower speed of the object to a higher speed of the object at two places within the detection area, the speed ratio being calculated on the basis of the position of the object measured by the position measuring unit, is equal to or lower than a certain value.

3. An operation determining system, comprises:
a position measuring unit that measures a position of a moving object with time; and
an operation determining unit that determines whether there is an operation of the object in a detection area based on an intersecting angle between entering and existing vectors of the object with respect to the detection area and a speed ratio of a lower speed of the object to a higher speed of the object at two places in the detection area, wherein
the intersecting angle and the speed ratio are calculated on the basis of the position of the object measured by the position measuring unit.

4. The operation determining system according to claim 1, wherein the entering and exiting vectors of the object are determined on the basis of the positions of the objects at two places striding over a boundary of the detection area.

5. The operation determining system according to claim 1, wherein the entering and exiting vectors of the object are determined on the basis of the positions of the object at two places adjacent to a boundary of the detection area.

6. The operation determining system according to claim 1, wherein the certain value of the intersecting angle between the vectors is set to a value in a range of from 30° to 180°.

7. The operation determining system according to claim 2, wherein the speed ratio corresponds to a ratio of a minimum speed of the object in the detection area to an entering speed of the object into the detection area.

8. The operation determining system according to claim 2, wherein the speed ratio corresponds to a ratio of a minimum speed of the object to a maximum speed of the object within the detection area.

9. The operation determining system according to claim 2, wherein the certain value of the speed ratio is set to a range of from 10% to 80%.

10. The operation determining system according to claim 1, wherein the object comprises one of a human hand, a human foot and a tip portion of a robot arm.

11. The operation determining system according to claim 1, wherein the position measuring unit measures a three-dimensional position of the object.

12. An operation determining device, comprising:
a unit that determines that there is an operation of a moving object in a detection area when an intersecting angle between entering and exiting vectors of the object with respect to the detection area, the intersecting angle being calculated on the basis of the position of the object determined by measuring the position of the moving object with time, is equal to or higher than a certain value.

13. An operation determining device, comprising:
a unit that determines that there is an operation of a moving object in a detection area when a speed ratio of a lower speed of the object to a higher speed of the object at two places within the detection area, the speed ratio being calculated on the basis of the position of the object determined by measuring the position of the moving object with time, is equal to or lower than a certain value.

14. An operation determining device, comprising:
a unit that determines that there is an operation of an object in a detection area, based on an intersecting angle between entering and exiting vectors of the object with respect to the detection area and a speed ratio of a lower speed of the object to a higher speed of the object at two places in the detection area, wherein
the intersecting angle and the speed ratio being calculated on the basis of the position of the object determined by measuring the position of the moving object with time.

15. A computer readable medium storing a program causing a computer to execute a process for determining an operation of a moving object, the process comprising:
determining whether an intersecting angle between entering and exiting vectors of the moving object with respect to a detection area is equal to or higher than a certain value or not, the intersecting angle being calculated on the basis of the position of the object which is determined by measuring the position of the moving object with time; and
determining that there is an operation of the object in the detection area when the intersecting angle between the vectors is equal to or higher than the certain value.

16. A computer readable medium storing a program causing a computer to execute a process for determining an operation of a moving object, the process comprising:
determining whether a speed ratio of a lower speed of the object to a higher speed of the object at two places in a detection area is equal to or lower than the certain value or not, the speed ratio being calculated on the basis of the position of the object which is obtained by measuring the position of the moving object with time; and
determining that there is an operation of the object when the speed ratio is equal to or lower than the certain value.

17. A computer readable medium storing a program causing a computer to execute a process for determining an operation of a moving object, the process comprising:
determining whether an intersecting angle between entering and exiting vectors of the object with respect to a detection area is equal to or higher than a first certain value or not, the intersecting angle being calculated on the basis of the position of the object which is determined by measuring the position of the moving object with time;
determining whether a speed ratio of a lower speed of the object to a higher speed of the object at two places in the detection area is equal to or lower than the second certain value or not, the speed ratio being calculated on the basis of the position of the object which is obtained by measuring the position of the moving object with time; and
determining that there is an operation of the object based on the intersecting angle and the speed ratio.
